(19) United States
(12) Patent Application Publication
(10) Pub. No.: US 2022/0124287 A1
(43) Pub. Date: Apr. 21, 2022

(54) Cloud-Based Vehicle Surveillance System

(71) Applicant: Michael Preston, Loxachatchee, FL (US)

(72) Inventor: Michael Preston, Loxachatchee, FL (US)

(21) Appl. No.: 17/505,201

(22) Filed: Oct. 19, 2021

Related U.S. Application Data
(60) Provisional application No. 63/094,499, filed on Oct. 21, 2020.

(51) Int. Cl. H04N 7/18; H04W 4/44; G06K 9/00; H04N 5/232; G06T 7/215; H04W 4/021; G08G 1/01; G06Q 40/08

(52) U.S. Cl. CPC H04N 7/181; H04W 4/44; H04N 7/188; G06K 9/00718; H04N 5/23299; G06Q 40/08; H04W 4/021; G06K 9/00805; G08G 1/0129; G06K 9/00785; G06T 7/215

(57) ABSTRACT

The present invention relates generally to the field of vehicle safety and monitoring systems. More specifically, the present invention relates to a cloud-based vehicle surveillance system for personal and commercial vehicles. The cloud-based vehicle surveillance system is comprised of a plurality of video cameras that may be mounted inside or outside of a vehicle, or on roadside objects such as light poles, bridges, medians, etc. Further, video, photograph, and audio content recorded by the cameras can be uploaded to a cloud based server to enable individuals, insurance companies, police departments and the like to access the uploaded data for monitoring driving practices of drivers to increase/decrease insurance premiums, issue tickets/citations, etc.

### CROSS-REFERENCE TO RELATED APPLICATION

The present application claims priority to, and the benefit of, U.S. Provisional Application No. 63/094,499, which was filed on Oct. 21, 2020 and is incorporated herein by reference in its entirety.

### FIELD OF THE INVENTION

The present invention relates generally to the field of vehicle safety and monitoring systems. More specifically, the present invention relates to a cloud-based vehicle surveillance system for personal and commercial vehicles. The cloud-based vehicle surveillance system is comprised of a plurality of video cameras that may be mounted on the interior or exterior of a vehicle, or on roadside objects such as, but not limited to, light poles, bridges, medians, etc. Further, video, photographic and audio content recorded by the cameras can be uploaded to a cloud-based server to enable individuals, insurance companies and authorities to access the uploaded data for monitoring the driving practices of drivers to increase/decrease insurance premiums, issue tickets/citations, etc. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

Approximately 38,000 people die each year as a result of vehicular crashes in the United States, and between 4.4 million more people suffer non-fatal injuries, with many incurring significant disabilities as a result of their injuries. In fact, vehicular crashes are the leading cause of death in the United States for people aged 1-54. Most vehicular crashes are caused by factors such as speeding, drunk driving, distracted driving, unsafe driving, etc. However, once a multi-vehicle accident has occurred, it is sometimes difficult to identify the person/vehicle responsible for the accident. As a result, unsafe drivers may cause serious accidents and other drivers may not be able to rightfully place responsibility on the unsafe driver for legal or insurance purposes.

Further, various insurance companies insure drivers against accidents. However, with no information about an accident and the driving habits of the driver involved in an accident, the insurance rates for innocent and safe drivers can rise if involved in an accident, even if the same was not caused by said driver, thereby leading to significant increases in the diver's insurance premiums or loss of coverage altogether. As a result, this may cause substantial financial hardship to innocent and safe drivers who were involved in a crash only because of another unsafe driver.

Therefore, there exists a long-felt need in the art for a vehicle safety and monitoring system that enables a driver and others to monitor a particular vehicle. There is also a long-felt need in the art for a vehicle safety system that is capable of consistently identifying unsafe drivers and those who cause vehicular accidents. Moreover, there is a long-felt need in the art for a vehicle monitoring system that enables insurance companies to monitor traffic data to raise or lower premiums for specific drivers accordingly, wherein the increases or decreases in premiums are based on the driver's safe or unsafe driving habits. Further, there is a long-felt need in the art for a vehicle monitoring system that ensures that the proper driver is identified and cited for unsafe driving practices that may result in a vehicular accident and that enables companies and employers to obtain information regarding the driving habits of their commercial vehicle drivers. Finally, there is a long-felt need in the art for a vehicle safety and monitoring system that improves roadway safety, effectively reduces the number of vehicular accidents, and that is both safe and easy to use.

The subject matter disclosed and claimed herein, in one embodiment thereof, comprises a cloud-based vehicle surveillance system comprising of a plurality of video cameras. Each video camera is connected to a wireless network, wherein each video camera continuously records video and audio in its field of view, and uploads the video and audio to a cloud-based server. The cloud-based server is further comprised of an advanced image processor that can detect traffic violations, unsafe driving habits and the party at fault in a vehicular accident. Further, the system is comprised of an information database that contains contact information such as driver information, vehicle owner and insurance information of a driver involved in a vehicle accident or traffic violation. The system then sends the appropriate information to insurance companies and police/emergency responders if necessary.

In this manner, the novel cloud-based vehicle surveillance system of the present invention accomplishes all of the forgoing objectives, and provides a relatively safe, easy, convenient and effective solution for recording information on unsafe driving practices and accidents to prevent innocent and safe drivers from being punished because of the fault of unsafe drivers. The cloud-based vehicle surveillance system of the present invention is also advantageous to insurance companies due to the fact that it allows said companies to obtain information on safe or unsafe driving habits of drivers, and accordingly raises or lowers the premiums for specific drivers. The system also enables the recorded video/audio to be uploaded to servers, which are accessible by insurance companies and police departments, who may want to obtain information on vehicle driving-related data. In this manner, the safety and recording system improves ensures the rightful drivers are held responsible in the event of a vehicle accident, as well as discouraging other drivers from violating traffic laws and driving recklessly.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cloud-based vehicle surveillance system that is comprised of a plurality of video cameras that may be mounted on vehicles or roadside objects. Each video camera is connected to a wireless network, wherein each video camera continuously records video, photographs and audio in its field of view, and uploads the recorded content to a cloud-based server. The cloud-based server is further comprised of an advanced image processor that can detect traffic violations, unsafe driving habits and/or vehicle accidents.

The server may also be comprised of an information database that contains contact information wherein the cloud-based server retrieves driver, vehicle owner and insurance information of a driver involved in a traffic violation, unsafe driving habit or an accident. Further, the server then sends the information to insurance companies/providers, police/first responders, vehicle owners/drivers, towing services and other parties of the like. Accordingly, insurance companies may subscribe to the system so that they can take appropriate action such as increasing, decreasing or maintaining the insurance premium of their insured driver and/or vehicle. Further, police may subscribe and use the system to issue tickets and citations.

Accordingly, the system of the present invention provides users with mountable video cameras that record driving practices and accidents for their own benefit. As a result, drivers can prevent being unfairly penalized on their insurance rates for accidents that were not their fault. Further, the system can be used by police to enforce traffic laws and discourage violations of said laws by using the system to issue tickets or citations. As such, the system promotes a safer roadway experience wherein drivers may drive more safely based on the fact that they can easily be held accountable for any accident they are involved in or cause.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of one potential embodiment of a cloud-based vehicle surveillance system of the present invention in accordance with the disclosed architecture;

FIG. 2 illustrates a block diagram showing the essential components of one potential embodiment of a cloud-based vehicle surveillance system of the present invention in accordance with the disclosed architecture;

FIG. 3 illustrates a top view of an intersection having one potential embodiment of the cloud-based vehicle surveillance system of the present invention in accordance with the disclosed architecture;

FIG. 4 illustrates a top view of a multi-lane highway having one potential embodiment of the cloud-based vehicle surveillance system of the present invention in accordance with the disclosed architecture, wherein a plurality of cameras are physically attached to an overpass; and

FIG. 5 illustrates a flow diagram showing the steps taken at the cloud server of one potential embodiment of the cloud-based vehicle surveillance system of the present invention after receiving video and audio from the surveillance cameras and in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a vehicle safety and monitoring system that enables a driver and others to monitor a particular vehicle, and that is capable of consistently identifying unsafe drivers and those who cause vehicular accidents. Moreover, there is a long-felt need in the art for a vehicle monitoring system that enables insurance companies to monitor traffic data to raise or lower premiums for specific drivers accordingly, wherein the increases or decreases in premiums are based on the driver's safe or unsafe driving habits. Further, there is a long-felt need in the art for a vehicle monitoring system that ensures that the proper driver is identified and cited for unsafe driving practices that may result in a vehicular accident, and that enables companies and employers to obtain information regarding the driving habits of their commercial vehicle drivers. Finally, there is a long-felt need in the art for a vehicle safety and monitoring system that improves roadway safety, effectively reduces the number of vehicular accidents and is both safe and easy to use.

The present invention, in one exemplary embodiment, is comprised of a cloud-based vehicle surveillance system that records video, photograph, and audio data via high-resolution video cameras. Said cameras can be mounted to objects such as light poles, bridges, medians, vehicles, etc. wherein each camera is in wireless electrical communication with a cloud based server configured to receive video and audio data from one or more of the plurality of the high-resolution video cameras. Once received by the server, the video/photographs/audio are processed to detect the at-fault driver in a vehicle accident, any traffic violation that may have occurred and any unsafe driving habit or behavior of any involved driver. Further, the driver, vehicle owner and insurance information/company may be identified, wherein video/photograph/audio analysis of the accident can be sent to third parties such as an insurance companies and police.

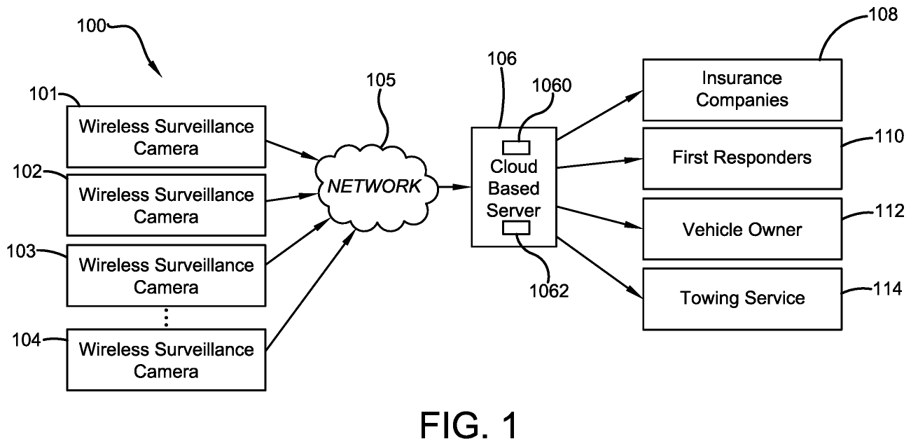

Referring initially to the drawings, FIG. 1 illustrates a schematic diagram of one potential embodiment of a cloud-based vehicle surveillance system 100 of the present invention in accordance with the disclosed architecture. As shown, the system 100 is comprised of a plurality of wireless surveillance cameras 101, 102, 103, 104 that are in wireless communication with a cloud-based server 106 through a communication network 105 via a wireless connection such as, but not limited to, a Wi-Fi, Bluetooth, Cellular, Satellite or GPS connection. In differing embodiments of the system 100, the surveillance cameras 101, 102, 103, 104 can be installed at various locations, or attached to various objects, along a roadway such as, but not limited to, light poles, bridges, medians, road signs, traffic lights, toll booths, etc. Further, the plurality of cameras 101, 102, 103, 104 may be installed on the vehicles themselves in locations such as, but not limited to, a vehicle roof, front/rear bumper, doors, within the vehicle headlights/tailights, on the front surface of vehicle mirrors, on the interior dashboard, on the interior surface of the front/rear windshield, etc.

As such, the plurality of cameras 101, 102, 103, 104 continuously record video and audio of the area in each camera's 101, 102, 103, 104 field of view (wherein each of said cameras are both tiltable and capable of panning) and upload or stream the video and audio to the connected cloud-based server 106. In addition, each of said plurality of cameras 101, 102, 103, 104 may capture still photographs in a plurality of time increments such as, but not limited to, every 15 seconds, 30 seconds, minute, or any other user specified time increment, or random time increments, etc. Further, each of the plurality of cameras 101, 102, 103, 104 may further be comprised of a decibel sensor that can be set such that when a decibel reading is detected above a set threshold decibel level (e.g., a decibel reading that would be achieved when a vehicular accident occurs), each of the plurality of cameras 101, 102, 103, 104 may begin recording video or capturing still photographs and audio. It is also contemplated that still photographs may be taken in a singular or rapid-burst fashion. In differing embodiments of the system 100, each of the plurality of cameras 101, 102, 103, 104 may also be comprised of a plurality of lenses that offer differing fields of view, and/or may possess certain characteristics such as infrared and/or night vision. Further, in the event of a traffic violation or an accident, video from multiple nearby cameras 101, 102, 103, 104 may be processed to eliminate false positive identifications during the analysis process.

Accordingly, the plurality of cameras 101, 102, 103, 104 collect a plurality of information about the vehicle to which they are mounted on, or on various vehicles traveling within a roadway (in an embodiment wherein the cameras 101, 102, 103, 104 are mounted on an object near the roadway as mentioned above). This information may also include, but is not limited to, vehicle speed, vehicle driving patterns (e.g. erratic driving), vehicle braking patterns (e.g. hard or sudden braking), vehicle direction, which vehicle struck another vehicle during an accident, the chain of events of an accident, vehicle make/model and an image of the vehicle driver and/or passengers. Once gathered, said information is then sent to and received by the cloud-based server 106 via the wireless connection, wherein the information may further be stored in a memory 1060 within the cloud-based server 106.

The information stored in and processed by the central server 106 can then be accessed and reviewed in real time, or at a later time, by third parties such as insurance companies 108, police/emergency first responders 110, the vehicle owner 112, towing services 114 and other similar individuals, organizations or entities. The cloud server 106 may also be comprised of an image processing system that can extrapolate a vehicle's registration, license plate and driver identity via the plurality of cameras 101, 102, 103, 104. The image processing system may possess enhanced video analysis capabilities that can isolate specific frames of a video recording taken by the plurality of cameras 101, 102, 103, 104 to show, for example, a distracted driver eating, using a device, speeding, not wearing a seatbelt, hitting another vehicle (e.g. critical events), etc., which may be captured and highlighted to form a short video clip that can be sent to police 110, insurance companies 108, etc . . . . Said clips may also include a timestamp, a camera identity number and the GPS location of the critical events, which may all be saved and transmitted along with the video/photograph and audio transmission.

Further, the server 106 may be comprised of a database 1062 that contains contact information such as, but not limited to, the vehicle owner's contact information and registration, driver's contact information, driver's license, insurance company information, emergency contact information, etc., and other contact details of the like. Based on the level of information required by each third party, a plurality of relevant information can also be provided and obtained. For example, information regarding the driving habits of the driver, traffic violations/ticket history of a driver, and driver and vehicle accident history can be provided to an insurance company by whom the driver and the vehicle are insured. Additionally or alternatively, information regarding the second driver and/or vehicle that was struck, or who struck the first driver and vehicle, may also be obtained. The retrieval of said information enables insurance companies to raise, lower, or maintain premiums for specific drivers based on their safe or unsafe driving habits. Further, insurance companies may be able to access the server 106 on a subscription-based payment model.

Similarly, the incident information, such as a video, photograph and audio recordings with appropriate driver and vehicle information and history (e.g. past accidents, tickets/violations, stolen vehicle reports), can be sent to police and other first responders to aid in investigating an incident and/or in bringing criminal charges, and in issuing citations, tickets, warnings, etc. It is also contemplated that the collection and storage of the information within the server 106 will be secure and that any transmission of the same will be encrypted or otherwise protected against tampering. Further, information regarding an accident or unsafe driving habits, as well as recommendations and alerts, can also be sent to a registered vehicle owner 112 or driver for their own records via a report in the form of a text message, email, PDF, mobile application interface, etc. For commercial vehicles, information about the location, accident report and driving patterns of the driver and/or the vehicle can be sent to the driver's employer and/or the vehicle owner.

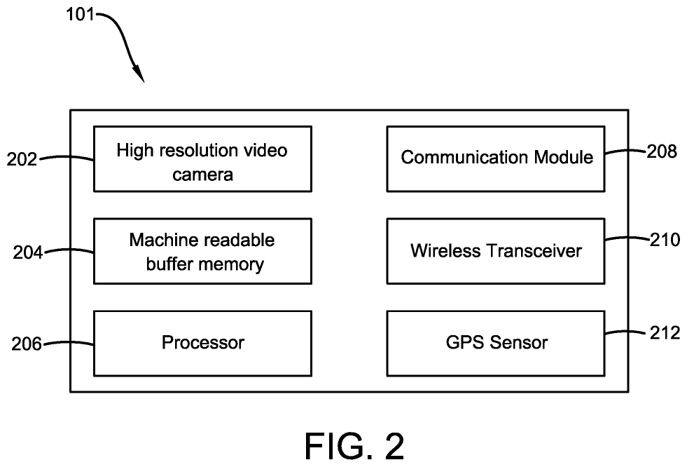

FIG. 2 illustrates a block diagram showing the essential components of one potential embodiment of a cloud-based vehicle surveillance system 100 of the present invention in accordance with the disclosed architecture. As shown, a camera assembly 101 captures high speed video/photographs/audio in high resolution within the field view of the camera 101. The high resolution further enables even small details, such as the driver's face and the license plate of a vehicle, to be easily identified. Further, a wireless communication module 208 is present within the camera 101 to allow the camera 101 to wirelessly connect to the cloud server 106, so that the recorded video, photographs, and audio data can be uploaded using a wireless transceiver, 210 which may transmit the recorded information via RF, satellite, Bluetooth, Wi-Fi, RFID, cellular connection, etc. Each of the plurality of surveillance cameras 101, 102, 103, 104 used in the system 100 may also be comprised of a GPS sensor 212 to identify the location of the surveillance camera 101 so that the location of any event captured by the surveillance camera can be readily ascertained. The GPS sensor 212 data may also be sent to the cloud server 106 as metadata, along with the video and audio information.

Each surveillance camera 101, 102, 103, 104 of the system 100 may also be comprised of a machine-readable buffer memory 204 to temporarily record the video, photograph and audio data for buffering. Any form of physical and/or tangible computer-readable media including a hard disk, magnetic tape, or any other magnetic/optical/physical medium, RAM, PROM, EPROM or FLASH-EPROMA may be used as memory for each of the plurality of cameras 101, 102, 103, 104. Further, a processor 206 controls the operations of all components of the surveillance cameras. As stated above, each surveillance camera 101,102,103,104 may also pan, tilt and zoom, and may be further comprised of a vehicle-tracking feature, wherein each surveillance camera 101, 102, 103, 104 pans and/or tilts with the movement of each vehicle that passes, or with the movement of each vehicle involved in an accident. The video processor 206 of the surveillance cameras 101, 102, 103, 104 may also distinguish between the foreground containing moving objects, such as vehicles, and the background containing static objects during the panning/tilting process.

In one embodiment of the present invention, each surveillance camera 101, 102, 103, 104 can also be in wireless communication with every other camera 101, 102, 103, 104 present within a specific distance radius or geofence, which can be specified by the user during the installation of the cameras 101, 102, 103, 104, or remotely through a central management server or mobile application. The inter-camera communication can then be used in a situation where a vehicle-mounted camera 101, 102, 103, 104 detects speeding or other erratic driving of a vehicle, so that a signal can be sent to other nearby surveillance cameras 101, 102, 103, 104 installed at, for example, a light pole or a bridge for proper and accurate audio and video capturing of a potential accident or unsafe driver.

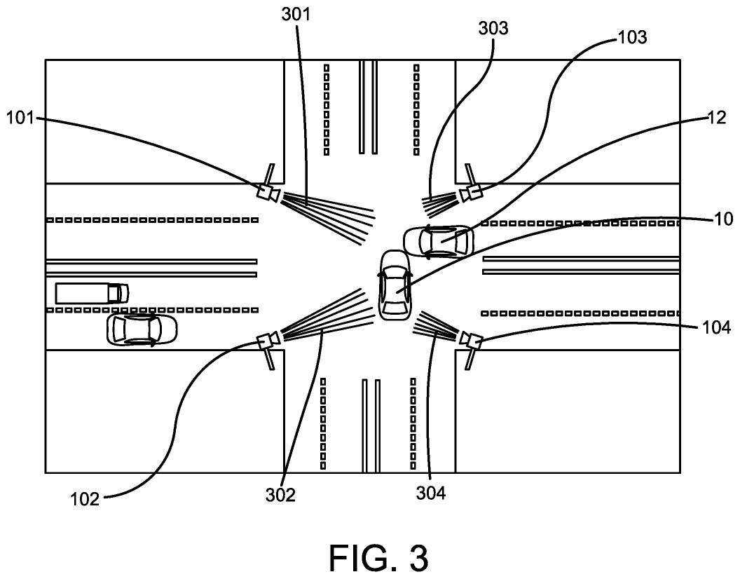

FIG. 3 illustrates a top view of an intersection having one potential embodiment of the cloud-based vehicle surveillance system 100 of the present invention in accordance with the disclosed architecture. As shown, the plurality of surveillance cameras 101, 102, 103, 104 may be installed at the corners of an intersection to completely cover the intersection area, and to capture and record vehicle movement and any accidents that may take place in proximity thereto. As shown, each of the plurality of surveillance camera 101, 102, 103, 104 has its own field of view 301, 302, 303, 304. For example, the first camera 101 has a field of view 301, and the second camera 102 has its own field of view 302. Likewise, the third camera 103 has a field of view 303, and the fourth camera 104 has its own field of view 304. Accordingly, a vehicle 10 at the intersection is covered by one or more of the cameras 101, 102, 103, 104, each of which captures the movement and other details of the vehicle 10 and any accident between the vehicle 10 and a second vehicle 12.

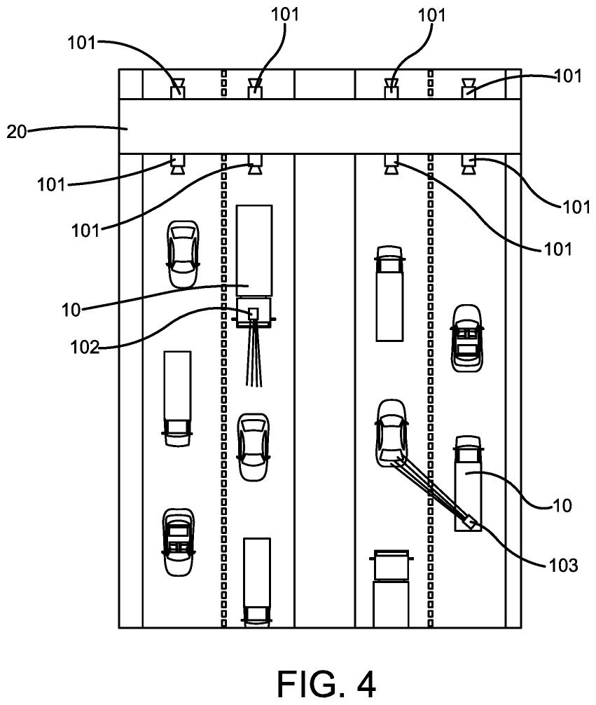

FIG. 4 illustrates a top view of a multi-lane highway having one potential embodiment of the cloud-based vehicle surveillance system 100 of the present invention in accordance with the disclosed architecture, wherein a plurality of cameras are physically attached to an overpass or bridge 20. As noted above, a first surveillance camera 102 may be installed on top or inside of vehicle 10, and a second surveillance camera 103 may also be installed on top or inside of the vehicle 10. More specifically, the cameras 101, 102, 103, 104 may come pre-installed with the vehicle 10, or can be installed at a later point in time by the owner of the vehicle 10. Each camera 101, 102, 103, 104 then captures the audio and video within its field of view as the vehicle is being driven, and uploads the captured audio and video to a cloud server 106. As noted above, each of cameras 101, 102, 103, 104 may also be in wireless communication with one or more of the remaining cameras so that, in the event of an accident, each camera 101, 102, 103, 104 tilts or pans in the direction in which the accident has occurred or is occurring, even when the cameras 101, 102, 103, 104 are locating in moving vehicles 10.

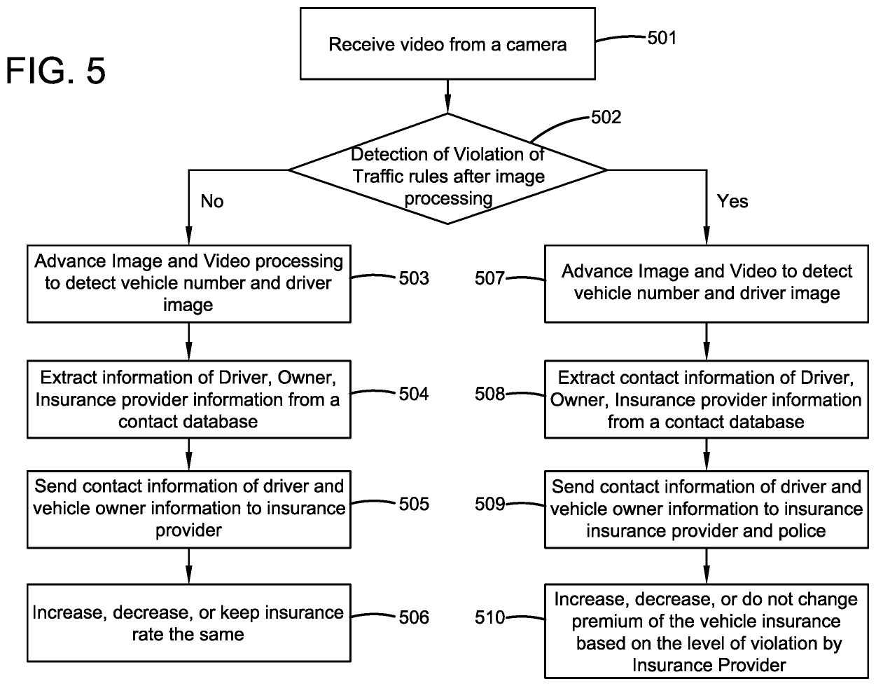

FIG. 5 illustrates a flow diagram showing the steps taken at the cloud server 106 of one potential embodiment of the cloud-based vehicle surveillance system 100 of the present invention, after receiving video and audio from the surveillance cameras and in accordance with the disclosed architecture. It should be noted that this particular embodiment of the system 100 can be used by an insurance company/provider 108 to raise, lower or maintain a driver's premium based on his or her driving habits or history of accidents. However, the system 100 can also function in a similar manner to assist police in issuing tickets/citations for traffic violations. Initially, the video, photographs and audio are received in real time from a camera 101, 102, 103, 104 of the system 100, wherein the media contains a location, camera identification, timestamp and other metadata as noted above (Block 501). Then, image processing analysis determines if a traffic law/rule has been violated (Block 502). If a violation is detected, then the system 100 performs an advanced image and video processing procedure to detect the vehicle license plate number and driver image (Block 507). Further, the contact information of the driver and/or vehicle owner, as well as his or her respective insurance provider information, may be extracted from a contact database (Block 508). It should also be noted that the mechanisms outlined in blocks 507 and 508 can take place simultaneously. Then, the contact information of the driver and/or vehicle owner is sent to the insurance company/provider and/or police if needed (Block 509). Based on the video and audio evidence provided, the insurance premium of the vehicle can then be increased, decreased or maintained at the discretion of the insurance provider (Block 510).

Similarly, if a traffic violation is not detected, advanced image and video processing may still be used to detect the vehicle license and/or driver image (Block 503). Also, the contact information of the driver and/or vehicle owner, as well as the insurance company/provider information, may be extracted from a contact database (Block 504). The contact information of the driver and/or vehicle owner may then be sent to an insurance company/provider (Block 505). Accordingly, the insurance premium can then be increased, decreased or maintained at the discretion of the insurance company (Block 506).

Many of the features of the video and audio recording, analyzing methods and systems described above include computing elements, such as servers, processors and the like. A person skilled in the art will appreciate that software, firmware or some combination thereof may be used to perform one or more of the functions of the disclosed surveillance system 100. The software and/or firmware may be any suitable computer-readable medium that has computer-executable instructions that may be executed by any computing machine or other computing device. It will also be appreciated that variations of the above-disclosed surveillance system and other features and functions, or alternatives thereof, may be desirably combined into many other different systems, methods or applications.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cloud-based vehicle surveillance system” and “system” are interchangeable and refer to the cloud-based multifunctional video surveillance system 100 of the present invention.

Notwithstanding the forgoing, the cloud-based vehicle surveillance system 100 of the present invention can be of any suitable configuration as is known in the art without affecting the overall concept of the invention, provided that it accomplishes the above-stated objectives. One of ordinary skill in the art will appreciate that the size, configuration and specification of the components of the cloud-based vehicle surveillance system 100 as shown in the FIGS. are for illustrative purposes only, and that many other configurations of the cloud-based vehicle surveillance system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cloud-based vehicle surveillance system comprising:
a plurality of cameras; and
a server.

2. The cloud-based vehicle surveillance system of claim 1, wherein the server is cloud-based.

3. The cloud-based vehicle surveillance system of claim 2, wherein each of the plurality of cameras are in wireless communication with the server and with other of the plurality of cameras positioned within a geofence.

4. The cloud-based vehicle surveillance system of claim 1, wherein each of the plurality of cameras record one or more of a high resolution video, a photograph, and an audio of a plurality of vehicles on a roadway.

5. A cloud-based vehicle surveillance system comprising:
a plurality of cameras;
a cloud based server;
a database; and
a subscription feature.

6. The cloud-based vehicle surveillance system of claim 5, wherein the subscription feature enables at least one of an insurance company and a police department to access the cloud-based vehicle surveillance system.

7. The cloud-based vehicle surveillance system of claim 5, wherein the database comprises a vehicle owner's contact information and registration, a driver's contact information, a driver's license, a driver's insurance company information, a driver's emergency contact information, a history of the driver's driving habits, a history of the driver's traffic violations, and a history of the driver's vehicular accident history.

8. A cloud-based vehicle surveillance system comprising:
a plurality of high-resolution cameras mounted on a plurality of objects and a plurality of vehicles;
a cloud based server;
a database that comprises a plurality of driver and insurance related information; and
a subscription feature that allows a police department and an insurance company to access the plurality of driver and insurance related information in the database.

9. The cloud-based vehicle surveillance system of claim 8, wherein the plurality of objects comprises a light pole, a bridge, a median, a road sign, a traffic light and a toll booth.

10. The cloud-based vehicle surveillance system of claim 9, wherein at least one of the plurality of high-resolution cameras is mounted on at least one of a vehicle's headlight of tailight, a front surface of a vehicle's mirrors, an interior dashboard of the vehicle, or on an interior surface of the front or rear windshield of the vehicle.

11. The cloud-based vehicle surveillance system of claim 10, wherein each of the plurality of high-resolution cameras capture a still photograph in a plurality of time increments.

12. The cloud-based vehicle surveillance system of claim 11, wherein each of the plurality of high-resolution cameras is comprised of a decibel sensor, and further wherein when said decibel sensor detects a decibel reading above a predefined threshold, said plurality of high-resolution cameras begin to capture a video and an audio of an area generating the decibel reading.

13. The cloud-based vehicle surveillance system of claim 12, wherein each of the plurality of high-resolution cameras may record a vehicle speed, a vehicle driving pattern, a vehicle braking pattern, a vehicle direction, an accident, a chain of events leading to the accident, a vehicle make and model, and an image of a driver and a passenger of the vehicle.

14. The cloud-based vehicle surveillance system of claim 13, wherein the cloud based server is comprised of an image processing system.

15. The cloud-based vehicle surveillance system of claim 14, wherein the image processing system is comprised of an enhanced video analytical capability that can isolate a specific frame of a video recording.

16. The cloud-based vehicle surveillance system of claim 15, wherein each of said plurality of high-resolution cameras comprise a pan, tilt and zoom capability, and a vehicle tracking feature.

17. The cloud-based vehicle surveillance system of claim 16, wherein each of said plurality of high-resolution cameras is comprised of a video processor that distinguishes a foreground containing a moving object from a background containing a static object.

18. The cloud-based vehicle surveillance system of claim 17, wherein each of said plurality of high-resolution cameras is comprised of a wireless communication module and a wireless transceiver.

19. The cloud-based vehicle surveillance system of claim 18, wherein the wireless transceiver transmits a set of recorded information to the cloud based server via an RF, a satellite, a Bluetooth, a Wi-Fi, a RFID or a cellular connection.

20. The cloud-based vehicle surveillance system of claim 19, wherein each of the plurality of high-resolution cameras comprises an infrared capability and a night vision capability.
